(19) United States
(12) Patent Application Publication
(10) Pub. No.: US 2026/0181418 A1
(43) Pub. Date: Jun. 25, 2026

(54) TRUSTED MESH NETWORK PROVISIONING BASED ON PHYSICAL CHANNEL CHARACTERISTICS

(71) Applicant: Intel Corporation, Santa Clara, CA (US)

(72) Inventors: Ilil BLUM SHEM-TOV, Kiryat Tivon (IL); Yaron KLEIN, Rosh Haayin (IL); Dan HOROVITZ, Rishon Letzion (IL); Yoni KAHANA, Kfar Hess (IL); Omer BEN-SHALOM, Rishon Le-Tzion (IL)

(21) Appl. No.: 18/991,786

(22) Filed: Dec. 23, 2024

(51) Int. Cl. H04W 24/02; H04B 17/309; H04W 84/18

(52) U.S. Cl. CPC H04W 24/02; H04B 17/309; H04W 84/18

(57) ABSTRACT

Disclosed herein are devices, methods, and systems for channel-condition-based provisioning in a wireless mesh network. The channel-condition-based provisioning system determines a set of channel conditions over a plurality of wireless channels between a wireless node and one or more other wireless nodes, wherein the set of channel conditions are based on current channel state information for the plurality of wireless channels. The channel-condition-based provisioning system determines a deviation between the set of channel conditions and a set of expected channel conditions for the plurality of wireless channels. The channel-condition-based provisioning system sets/enforces a wireless network policy with respect to the wireless node based on the deviation.

### BACKGROUND

The use of mesh networks has become increasingly popular due to their ability to provide robust and scalable wireless connectivity in various environments. Existing mesh network solutions often offer user-friendly onboarding processes that typically involve two straightforward steps: selecting the network and entering a password. These steps leverage standard wireless protocols and mechanisms to provide simple device discovery and secure integration. While these solutions may be effective for devices with user interfaces (UI) or direct user access, they may be inadequate for small-form devices like Internet of Things (IoT) devices that lack such user-interfaces. In addition, many devices, such as sensors, traffic lights, thermometers, water meters, etc., may operate autonomously and are often deployed automatically in inaccessible or remote locations. For these devices, onboarding and provisioning present significant challenges. Current approaches rely on manual configuration or physical access to the device, which are labor-intensive, error-prone, and infeasible at scale. In addition, existing provisioning methods may compromise security by over-simplifying provisioning or may provide more enhanced security by requiring complex setups involving external tools or specialized equipment. However, the lack of an easy, secure, and scalable solution for onboarding IoT devices has hindered the widespread deployment and adoption of IoT systems in various industries.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a channel-condition-based provisioning system where an edge/node device may determine whether new nodes are trusted nodes in the mesh network or whether some action should be taken in respect of the network's security policy;

FIG. 2 illustrates an example sequence diagram for an administrator-controlled training phase for a channel-condition-based provisioning system;

FIG. 3 provides an example of sequence diagram for the operational phase of two nodes participating in a mesh network, where each may check the authenticity of the other node;

FIG. 4 shows an example of a prediction model (e.g., a neural network, learning model, statistical model, etc.) that may be trained to take a matrix of channel conditions of a node as an input and then output a determination as to whether the device should be trusted;

FIG. 5 illustrates an exemplary schematic drawing of an apparatus for channel-condition-based provisioning; and

FIG. 6 depicts an exemplary schematic flow diagram of a method for channel-condition-based provisioning.

### DESCRIPTION

The following detailed description refers to the accompanying drawings that show, by way of illustration, exemplary details and features.

The word “exemplary” is used herein to mean “serving as an example, instance, or illustration”. Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [. . . ], etc., where “[. . . ]” means that such a series may continue to any higher number). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [. . . ], etc., where “[. . . ]” means that such a series may continue to any higher number).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

As used herein, the terms “display,” “monitor,” “television,” “video display,” “screen,” etc. refer to a hardware device that illuminates in order to display a series of images or frames. The illumination may be direct (such as with a cathode ray tube (CRT) display, a liquid crystal (LCD) display, light-emitting diode (LED) display, etc.) or indirect (such as with a projector or other projection methods). As should be understood, most displays are configured to receive a stream of digital video information that represents a set of continuous video frames, where each frame may contain a digital representation of the image to be displayed (e.g., “active” pixels in a horizonal and vertical dimension of the active/visible portion of the frame) and control or other information that is not part of the active/visible portion of the image to be displayed but nevertheless make up the overall size of the frame (e.g., horizontal/vertical blanking of lines, columns, pixels, etc.).

Various embodiments herein may utilize one or more machine learning models to perform functions of the vehicle (or other functions described herein). The term “model” as, for example, used herein may be understood as any kind of function or algorithm, which provides output data from input data. A machine learning model may be executed by a computing system to progressively improve performance of a specific task. In some aspects, parameters of a machine learning model may be adjusted during a training phase based on training data and a trained machine learning model may then be used during an inference phase to make predictions or decisions based on input data. In some aspects, the trained machine learning model may be used to generate additional training data and an additional machine learning model may be adjusted during a second training phase based on the generated additional training data. A trained additional machine learning model may then be used during an inference phase to make predictions or decisions based on input data.

The machine learning models described herein may take any suitable form or utilize any suitable techniques. For example, any of the machine learning models may utilize supervised learning, semi-supervised learning, unsupervised learning, or reinforcement learning techniques.

In supervised learning, the model may be built using a training set of data that contains both the inputs and corresponding desired outputs. Each training instance may include one or more inputs and a desired output. Training may include iterating through training instances and using an objective function to teach the model to predict the output for new inputs. In semi-supervised learning, a portion of the inputs in the training set may be missing the desired outputs.

In unsupervised learning, the model may be built from a set of data which contains only inputs and no desired outputs. The unsupervised model may be used to find structure in the data (e.g., grouping or clustering of data points) by discovering patterns in the data. Techniques that may be implemented in an unsupervised learning model include, e.g., self-organizing maps, nearest-neighbor mapping, k-means clustering, and singular value decomposition.

Reinforcement learning models may be given positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various embodiments described herein may utilize one or more classification models. In a classification model, the outputs may be restricted to a limited set of values. The classification model may output a class for an input set of one or more input values. An input set may include sensor data, such as image data, radar data, and the like. A classification model as described herein may for example classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various embodiments described herein may utilize one or more regression models. A regression model may output a numerical value from a continuous range based on an input set of one or more values. References herein to regression models may contemplate a model that implements, e.g., any one or more of the following techniques (or other suitable techniques): linear regression, decision trees, random forest, or neural networks.

A machine learning model described herein may be a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network or a sum-product neural network and the like. The neural network may include any number of layers and the training of the neural network, e.g. adapting the layers of the neural network, may be based on any kind of training principle, such as backpropagation, e.g. a backpropagation algorithm.

As noted earlier, the onboarding of IoT devices (also called provisioning), especially for those devices that are autonomous and/or lack a user interface or without direct user access, may be complex or present security risks. Until now, there has been no secured, holistic approach for onboarding devices into a mesh network. Current onboarding techniques may provide for discovery and detection that are needed for onboarding but they lack the necessary security. The term “onboarding” in a mesh network is the processes used to add new devices (also called “nodes”) to the mesh network so that they may communicate effectively with the existing infrastructure (e.g., the other nodes within the mesh). Some common onboarding techniques for mesh networks include, automatic node discovery, manual configuration, security authentication, zero-touch provisioning (ZTP), quick response (QR)-Code scanning, near-field-communication (“NFC”) pairing (e.g., Bluetooth pairing), mesh network management software, etc.

When designing or implementing a mesh network, it may be important to consider specific requirements, such as the level of security needed within the network, the technical expertise expected of the users of the network, and the expected scale of the network. Given that networking is provided by its member nodes, the mesh network may benefit from an onboarding process that is both simple and secure so as to encourage growth and to maintain the robustness of the network. Detecting new nodes for onboarding in a mesh network typically involves a discovery process where existing nodes of the mesh network listen for signals or messages from new devices that wish to join the network. Common methods for detecting new nodes in a mesh network include:

Broadcasting: In this method, new nodes may broadcast a message indicating their presence and desire to join the network. Existing nodes that receive this broadcast message may then respond, initiating the onboarding process. This provides a way of detecting devices that want to join the network, but this detection does not provide a trust framework for authorizing the new device.

Beacon Frames: In this method, existing nodes of a mesh network may send out beacon frames at regular intervals (e.g., on a beacon channel). These beacon frames may be transmitted to indicate that a network is present. When a new node receives a transmitted beacon frame, the new node may take action to join the network by responding to the beaconing node. Again, this provides a way of detecting devices that want to join the network, but this detection does not provide a trust framework for authorizing the new device.

Neighbor Discovery Protocol (NDP): Protocols like NDP may be used as a way of discovering neighboring (or nearby) devices. NDP operates at the link layer and helps nodes determine the reachability of neighboring nodes, as well as discovering new nodes trying to join the network. One drawback of this method is that it is not suitable for all nodes and, like the other methods, provides only a way of detecting devices, not a trust framework for authorizing the new device.

Multicast: Some mesh networks broadcast “multicast” messages that provide for local network discovery. New nodes may listen for these messages to detect the presence of a mesh network and then announce themselves to the network. Like the other methods, this may provide a way of detecting devices, not it does not provide a trust framework for authorizing the new device.

Service Discovery Protocols: Protocols such as multicast domain name service (mDNS) or simple service discovery protocol (SSDP) may allow devices to discover each other on a local network by broadcasting (or multicasting) queries to which a new node may respond. Like the other methods, this may provide a way of detecting devices, not it does not provide a trust framework for authorizing the new device.

Probing: In this method, existing nodes may periodically send out probe messages to discover new nodes. These messages can be unicast, multicast, or broadcast, depending on the network's design. New nodes that receive these probes can reply to indicate their presence. Like the other methods, this may provide a way of detecting devices, not it does not provide a trust framework for authorizing the new device.

Active Scanning: In this method, new nodes may actively scan signals from existing nodes in the mesh network. This may involve listening for beacon frames or sending out probe requests to which existing nodes can respond. Like the other methods, this may provide a way of detecting devices, not it does not provide a trust framework for authorizing the new device.

Passive Scanning: Instead of actively sending out messages, new nodes may use a method by which they passively listen for ongoing communication within the mesh network to identify potential points of connection. Like the other methods, this may provide a way of detecting devices, not it does not provide a trust framework for authorizing the new device.

Physical Layer Monitoring: Another method is that nodes may monitor the physical layer for any activity that indicates the presence of a new node, such as unexpected radio frequency signals. Like the other methods, this may provide a way of detecting devices, not it does not provide a trust framework for authorizing the new device.

Network Management Tools: Some mesh networks are managed by network management software that may detect new nodes through various discovery protocols and facilitate their integration into the network. Like the other methods, this may provide a way of detecting devices, not it does not provide a trust framework for authorizing the new device.

After a detection method detects a new node, the mesh network typically goes through an authentication and authorization process to ensure that the new node is allowed to join the network. This authentication process helps maintain the security and integrity of the mesh network. After successful authentication, the new node may be configured with the necessary network settings and begin participating in the mesh network's routing, data transmission, and data communication processes.

In terms of authentication, as noted earlier, authentication may include methods such as automatic node discovery, manual configuration, security authentication, ZTP, QR-Code scanning, NFC pairing, mesh network management software, etc. Each of these methods may not provide sufficient security. For example, with automatic node discovery, the mesh networks may be designed to automatically detect and configure new nodes so that when a new device is powered on within the network's range, the new node broadcasts a message seeking to join the network. Existing nodes can respond, allowing the new node to establish connections and become part of the mesh. This method is not necessarily secure, and even if security methods are employed, the security information is easily spoofed.

With the example of manual configuration, the node may need to, before it may join the mesh network, be manually configured with the required settings of the mesh network it intends to join. This may include settings such as internet protocol (IP) addresses, network identifiers (IDs), other security credentials, configuring gateways or bridges that connect the mesh network to the broader network/internet, etc. However, as with the automatic node discovery, the security credentials may be easily faked or spoofed. If a security authentication method is used to prevent unauthorized access, the mesh network may implement security protocols that require new nodes to authenticate before joining. This may involve pre-shared keys, digital certificates, and/or a secure handshake process to ensure the integrity and confidentiality of the network. For example, with provision certificates, this method requires that each edge device/node is provisioned with a certificate in advance and each device may then authenticate all other devices before full connection is available. Not all types of nodes may support storing such certificates and, even so, the certificates may be easily stolen so and used to deploy unauthorized nodes. This is also the case with ZTP, which, although ZTP allows devices to be provisioned and configured automatically with minimal human intervention by retrieving a configuration file from a central server based on its unique identifiers, not all types of nodes may support storing such certificates and, even so, the certificates may be easily stolen so as to be used to deploy unauthorized nodes.

With QR-scanning, this method provides a QR-code that the provisioning user may scan to obtain the necessary protocol information to provision the device and allow it to configure itself on the network. However, this method does not offer security. With NFC pairing, the existing device and the new device may exchange the necessary information for network onboarding through a secure channel, but not all nodes support secure channel technologies. Mesh network management software tools may facilitate the onboarding process by providing a user interface to monitor and control the addition of new nodes. These tools may also help with configuring, updating, and managing the network, but this may be complex and require a management software program. In addition, remote nodes may be difficult to monitor remotely. And as mesh networks grow, these conventional methods for onboarding may increase in complexity, especially in terms of security.

Unlike these conventional methods, channel-characteristic-based onboarding is disclosed below. In particular, channel-characteristic-based onboarding may utilize the uniqueness of channel state information (e.g., CSI information (e.g., a matrix of CSI information over multiple channels) (e.g., a CSI matrix)) as between two wireless nodes to provide a “fingerprint” of one node with respect to the other. With reference to the fingerprint, each node may be able to detect whether the other node has been hacked (e.g., the medium access address (MAC address) of the other node may have been spoofed by an unauthorized device, and the historical channel state information provides a pattern against which current channel state information may be compared. If changes are detected between the current channel state information and the fingerprint for the channel state information (e.g., their difference satisfy a predetermined criterion), the node may set/enforce a wireless network policy with respect to the other node, e.g., that the other node be quarantined, kicked out of the network, its data packets dropped, and/or flagged to a network controller for investigation (e.g., until re-approved or re-authenticated by a network administrator or another verification). By monitoring the set of channel conditions against a set of expected channel conditions, this may provide a secure authentication method that does not require user intervention that may increase mesh network security. Overall, channel-characteristic-based authentication may help mitigate the risk of unauthorized access and “man-in-the-middle” attacks in a mesh networking environment.

At a high level, the channel-characteristic-based authentication system determines a set of (expected) channel characteristics (also called channel conditions or channel information) that represent the radio frequency (RF) “fingerprint” between two nodes. Then, when the actual set of channel characteristics (e.g., periodically measured) deviate from the set of expected channel characteristics in prescribed manner (e.g., satisfy a predefined criterion), one of the nodes will be able to identify this deviation and react according to the network's security policy (e.g., setting/enforcing a wireless network policy with respect to the node: quarantine the node, drop its data packets, remove the node from the network, flag a network controller for investigating the node, re-route the data away from the node). As should be appreciated, the type of action taken by the node may depend on the security policies of the mesh network and may involve any type of action the node should take in response to detecting a deviation in the channel characteristics. As should be understood, if the deviation returns back to within an acceptable level (e.g., the one or more deviation criterion are no longer satisfied) or if a network administrator releases the suspect node, the suspect node may be released from quarantine, be allowed to transfer data packets, be allowed to rejoin the network, be unflagged from needing investigation, etc.

The set of expected channel conditions or “fingerprint” may be determined based during a training period (e.g., at the time of onboarding/provisioning or during an controller-initiated training procedure) in which the channel characteristics across various wireless parameters (e.g., over various different channels, in different transmission/reception modes, using various different antennas, using various different modulation schemes, etc.) is monitored to build a learning model that takes as an input the given wireless parameters and outputs a channel condition matrix as the expected channel conditions for the given wireless parameters. To be clear, the nodes need not be connected to the mesh network at the time of training. It is sufficient for the node to simply obtain channel conditions as part of any transmission/reception of wireless signals.

By periodically checking the current channel conditions (e.g., before each reception, at a regular interval, at a random interval, etc.), the nodes may continuously police the network to discover suspicious nodes that may need to be investigated, quarantined, its data packets dropped, flagged, and/or removed from the mesh network. This helps to ensure that only authorized nodes are participating in the mesh network—not only at the time of provisioning but also after provisioning—to continuously and persistently reverify the authenticity of the nodes involved in subsequent transactions within the mesh network.

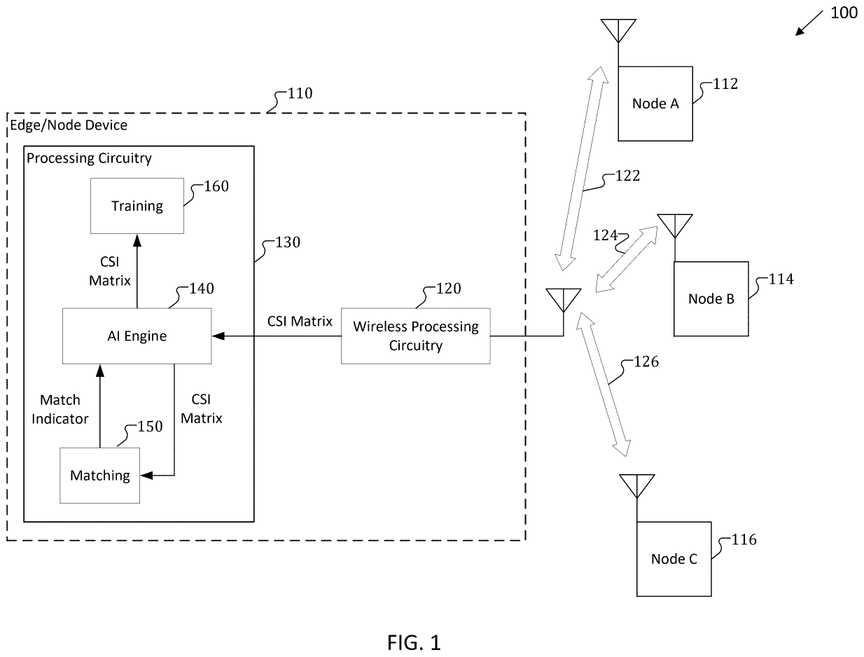

FIG. 1 shows an example of a channel-condition-based provisioning system where an edge/node device 110 may determine whether new nodes (e.g., node A (112), node B (114), and node C (116)) are trusted nodes that may be added to (or remain in) the mesh network, or whether some action should be taken in respect of the network's security policy (e.g., setting/enforcing a wireless network policy with respect to the node and/or its data). As should be understood, the separation of the various functions into logical circuitry (e.g., processor circuitry 130, wireless processor circuitry 120, artificial intelligence (AI) engine 140, etc.) is provided for ease of reference, but does not necessarily mean that these are physically separate components. As is understood, this functionality may be embedded in logical segments in the same hardware, software, and/or a combination of both and may be in the same or spread across any number of physical components.

Device 110 may include wireless processor circuitry 120 such as a wireless transceiver that is capable of transmitting/receiving radio frequency signals and may support one or more wireless/network protocols for near-field communication networks, wireless local area networks, cellular networks, etc., including those such as ZigBee, Bluetooth, Bluetooth Low Energy (LE), Wi-Fi, long term evolution (LTE), etc. The wireless processor circuitry may be able to obtain channel properties (e.g., channel state information (CSI)) of communication channels between the device 110 and the new nodes.

For example, device 110 may receive a CSI matrix for the communication channels 122 between device 110 and node A (112). In addition, device 110 may receive a CSI matrix for the communication channels 124 between device 110 and node B (114) and device 110 may receive a CSI matrix for the communication channels 126 between device 110 and node C (116). As should be understood, the obtained CSI matrix of information may be a single value representing the channel conditions (e.g., an instantaneous measurement or a statistical measurement of a single channel or a range of channels) at a single point in time, though it may be advantageous to obtain separate values for CSI information for a number of different channels and/or over time (and hence collect a matrix of multiple CSI values over various channels, subchannels, timeslots, over time, etc.) so as to obtain a more complete “picture” of the channel conditions with respect to the node. The device 110 may provide the CSI information (e.g., the CSI matrix) to processor circuitry 130 for determining whether the CSI information is for an authenticated node. For example, the processor circuitry 130 may compare the CSI matrix to an expected CSI matrix (e.g., a pre-determined matrix for the given node) to determine the extent of deviation. And if the extent of deviation satisfies a predefined criterion (e.g., exceeds a threshold level of deviation), the processor circuitry 130 may set/enforce a wireless network policy with respect to the new node (e.g., to quarantine the node, to remove the node from the network, to drop its data packets, to flag the node as requiring investigation, to release the node from quarantine, etc.) based on the extent of deviation.

To make this determination, the processor circuitry 130 may include or be an artificial intelligence (AI) engine 140 that takes as an input the CSI matrix of the new node and, based on trained model that matches (e.g., in 150) the input data to its training data, and labels the node as safe/verified, unsafe/unverified, or some other label as a match indicator. As should be appreciated, the AI engine 140 may also output a confidence score or other information indicating its certainty with respect to the extent of the certainty of its labeling/matching. The AI engine 140 may also use the received CSI matrix for training (e.g., in 160) the AI engine 140. In this regard, the processor circuitry may initiate a training phase during onboarding of the new node in order to obtain one or more sets of channel conditions (one or more CSI matrices) with respect to one or more communication channels with respect to the new node. This data may be then used to train the AI engine 140 as to the expected CSI matrix for various wireless situations, environmental conditions, physical locations, etc. As should be understood, a network controller may oversee the onboarding and/or provide instructions to device 110 for how/when to obtain or what to use for the expected CSI matrix “fingerprint” or for how/when device 110 should train the AI engine 140 with respect to the new node. Alternatively, storing of the expected CSI matrix and/or training may be performed automatically, when triggered, when authorized by a user, etc.

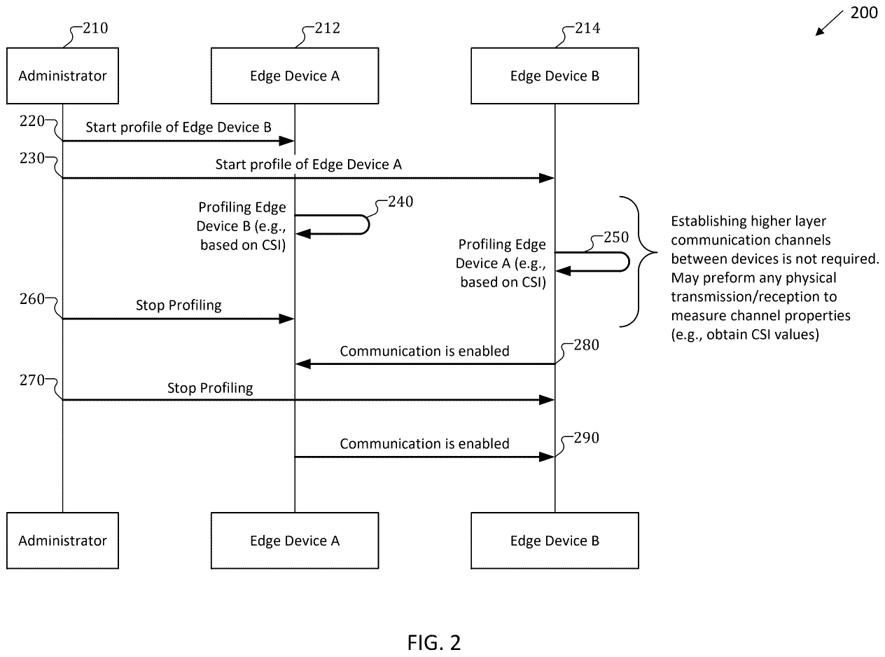

An example of an administrator-controlled training phase (also called profiling or fingerprinting) for a channel-condition-based provisioning system is shown in sequence diagram 200 of FIG. 2. The mesh network may be controlled by an administrator 210 who determines when a first node (e.g., node 212 or edge device A) and a second node (e.g., node 214 or edge device B) should profile one another in order to establish/reestablish the expected channel condition information each node may use as the basis for ensuring the authenticity of the other node. To trigger the profiling, the administrator 210 may send, for example, a message 220 to edge device A (node 212) indicating that it should begin profiling edge device B (node 214). The administrator 210 may also send, for example, a message 230 to edge device B (node 214) indicating that it should begin profiling edge device A (node 212). As should be appreciated, triggering the profiling for one node is not dependent on triggering the profiling of another node. Rather, the separate triggers of FIG. 2 (e.g., message 220 and message 230) simply indicate that each node may be instructed individually as to when, how, and at what time it should begin the profiling.

After receiving message 220, edge device A (node 212) begins profiling edge device B (profiling 240) by performing wireless transmissions and then, based on reflected signals, determining channel conditions of various wireless receiver channels (e.g. CSI value(s)). Profiling 240 may continue (over various channels, subchannels, timeslots, physical locations, etc.) taking measurements at different points time until the administrator 210 stops the profiling with message 260. The information gathered may then be stored in edge device A (node 212) or with the administrator 210 as the expected channel conditions (e.g., the “fingerprint” for comparison to actual channel conditions for determining authenticity/trust or the training data for a prediction model that uses the actual conditions as an input for outputting authenticity/trust) to be used during subsequent authentication(s) for whether the edge device B is to remain a trusted node in the mesh network. After profiling 240 is complete, edge device B is identified as a trusted node so that edge device B (node 214) is able to join the mesh network and communication 280 is enabled (e.g., edge device A will not discard edge device B's data packets, which are safe to communicate within the mesh network).

Similarly, message 230 may instruct edge device B (node 214) to perform a separate profiling (profiling 250) of edge device A (node 212). During profiling 250, edge device B may perform wireless transmissions and then, based on reflected signals, determining channel conditions of various wireless receiver channels (e.g. CSI value(s)). Profiling 250 may continue (over various channels, subchannels, timeslots, physical locations, etc.) taking measurements at different points time until the administrator 210 stops the profiling with message 270. The information gathered may then be stored in edge device B (node 214) or with the administrator 210 as the expected channel conditions (e.g., the “fingerprint” for comparison to actual channel conditions for determining authenticity/trust or the training data for a model that uses the actual conditions as an input for outputting authenticity/trust) to be used during subsequent authentication(s) for whether the edge device A is to remain a trusted node in the mesh network. After profiling 250 is complete, edge device A is identified as a trusted node so that edge device A (node 212) is able to join the mesh network and communication 290 is enabled (e.g., edge device B will not discard edge device A's data packets, which are safe to communicate within the mesh network).

As should be understood, the profiling (e.g., profiling 240 or profiling 250) may be performed while the nodes are at a fixed, physical location so as to improve the reliability that comparison of the actual channel conditions to the expected channel conditions may be used to reliably detect an unauthorized device/hacking. If the profiling is performed while the physical location is changing, it may be helpful to also record the physical location along with the measured channel conditions so that different “fingerprints” may be stored for each location or so that the trained model may also take into account location in its identification model. This is due to the fact that CSI values measured by a specific device uniquely describe the specific device's relationship to the other node in terms of their physical locations and other geometries that may impact signal propagation. In this sense, if a profiled node has moved or altered its state from when it was originally profiled, it may need to be re-profiled at the new location and/or in its altered state.

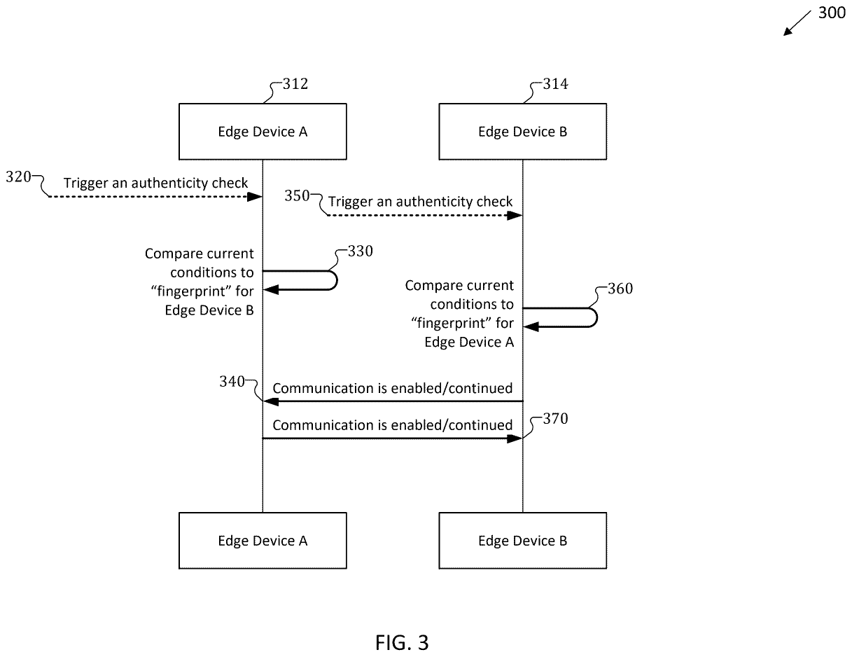

Once profiling is complete with respect to the two nodes (e.g., each node is a trusted node and may communicate data within the mesh network), each node may periodically (e.g., according to a trigger such as an administrator message, a receipt of a data from a given node, an elapsed time-period, randomly, etc.) check the authenticity of the other node that it has previously profiled. An example of this is shown in FIG. 3, which shows a sequence diagram 300 for a channel-condition-based provisioning system. Sequence diagram 300 shows a first node 312 (or edge device A) and a second node 314 (or edge device B) that have completed their respective profiling of one another (e.g., as described above with respect to, for example, FIG. 2). The first node 312 may receive a trigger 320 indicating that it should authenticate the second node 314 by comparing current channel conditions with the expected channel conditions previously established during the profiling. So, first node 312 may obtain the current wireless channel conditions 330 (e.g., a current CSI matrix) (e.g., as part of its normal operation or in response to a specific request to estimate channel conditions) with respect to second node 314. Then, first node 312 may compare the collected current wireless channel conditions 330 to the expected channel conditions (e.g., the “fingerprint” against which the current channel conditions 330 are compared or model that takes the current channel conditions 330 as an input to determine whether the current channel conditions 330 sufficiently match).

Depending on whether there is a sufficient match (e.g., whether the extent of the deviation satisfies a predefined criterion (e.g. a threshold)), the second node 314 is either verified as a trusted node that may continue to communicate data 340 within the mesh network or is not verified for communicating within the mesh network. If second node 314 is verified, first node 312 may continue to (or begin to) communicate data 340 with second node 314 within the mesh network. If second node 314 is not verified, first node 312 may react according to the network's security policy (e.g., by setting/enforcing a wireless network policy with respect to the node), as examples, discarding data packets communicated from second node 314, rerouting data paths to avoid second node 314, removing second node 314 from the mesh network, quarantining second node 314 (and/or its data) out of the mesh network, and/or flagging the second node 314 (e.g., to a network controller/administrator) for investigation. These security policies may be lifted/released if the second node 314 is verified (e.g., re-trusted or re-authenticated by a network administrator or other verification process).

Similarly, the second node 314 (edge device B) may receive a trigger 350 indicating that it should authenticate the first node 312 by comparing current channel conditions with the expected channel conditions previously established during the profiling. So, second node 314 may obtain the current wireless channel conditions 360 (e.g., a current CSI matrix) (e.g., as part of its normal operation or in response to a specific request to estimate channel conditions) with respect to first node 312. Then, second node 314 may compare the current wireless channel conditions 360 to the expected channel conditions (e.g., the “fingerprint” against which the current channel conditions are compared or model that takes the current channel conditions 360 as an input to determine whether the current channel conditions 360 sufficiently match).

Depending on whether there is a sufficient match (e.g., whether the extent of the deviation satisfies a predefined criterion (e.g. a threshold)), the first node 312 is either verified as a trusted node that may continue to communicate data 370 within the mesh network or is not verified for communicating within the mesh network. If first node 312 is verified, the second node 314 may continue to (or begin to) communicate data 370 with first node 312 within the mesh network. If first node 312 is not verified, second node 314 may set/enforce the wireless network policy with respect to the node to, as examples, discard data packets communicated from first node 312, reroute data paths to avoid first node 312, remove first node 312 from the mesh network, quarantine first node 312 (and/or its data) out of the mesh network, and/or flag the first node 312 (e.g., to a network controller/administrator) for investigation. These security policy restrictions may be lifted/released if the first node 312 is verified (e.g., re-trusted or re-authenticated by a network administrator or other verification process).

As noted above, wireless channel conditions may be collected (e.g., in the form of a CSI matrix) as part of a wireless receiver's regular channel estimation or as part of a specific request to determine properties of the current channels. Wireless channel conditions may be sensitive to any changes to the wireless channel, including a change in a physical location of the wireless node/device), a change in the physical hardware, etc. As such, a CSI matrix and changes thereto may serve as metric for determining whether to mark a node as trusted or not trusted. Because the CSI may include a number of different channel properties across a number of different channels, it is described herein as a “matrix.” And thus, the comparison of the current channel conditions to the expected channel conditions may involve any number of comparisons, correlations, analysis.

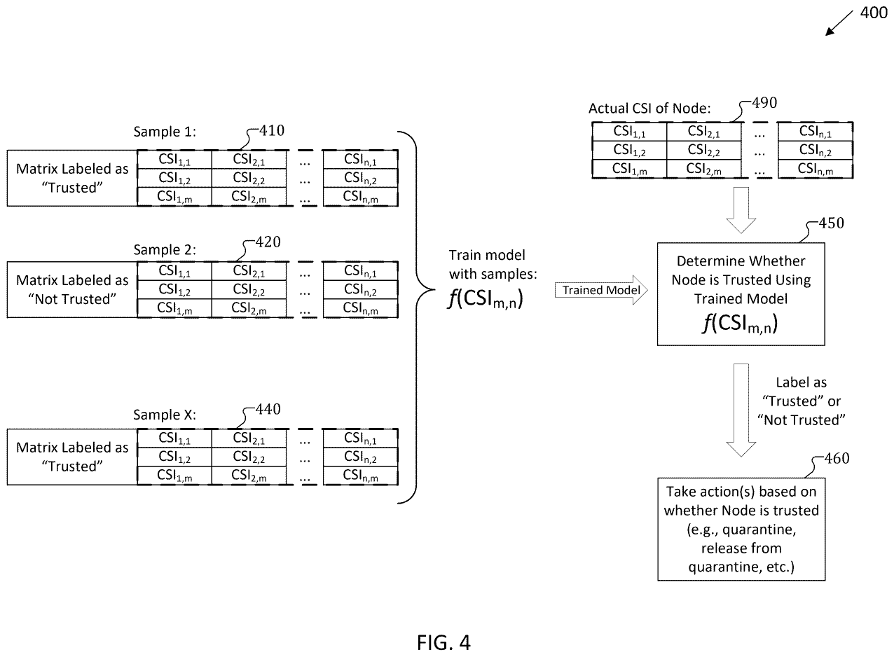

Given the extent of potentially available channel state information collected and potential comparisons, the comparison may be carried out using statistical methods and correlations and/or using a neural network/learning model that has been trained on relationships between data in a CSI matrix and to a determination of “trusted” or “not trusted” (or the extent thereof). FIG. 4 shows an example of a model (e.g., a neural network, learning model, etc.) that may be trained to take a CSI matrix of a node as an input and then output a determination as to whether the device should be trusted. FIG. 4 shows that a training model f(CSI_{m,n}) that have been trained using X number of sample 410 (Sample 1), sample 420 (Sample 2), and up to sample 440 (Sample X), each of which has been labeled with an identifier of “Trusted” or “Not Trusted.”

The CSI values are shown in a two dimensional matrix with a size of m,n, where m represents a channel (e.g., a symbol, a subchannel, a timeslot, a resource block, etc.) for which the value was collected and n represents the channel property determined (e.g., amplitude, phase, frequency response, multipath effects, time variability, spatial information, signal to noise ratio, path loss, delay, etc.). As should be appreciated the CSI matrix may include any number of dimensions for any number of channels, covering any number of channel properties or other properties that may be relevant to the CSI values (e.g., movement information, physical location information, time range/stamp, environmental information, etc.). As should also be understood, the CSI values may be instantaneous values, statistical values (e.g., over a time period), or a combination of both.

These labeled samples may be used to train the model f(CSI_{m,n}), which, in the channel-condition-based provisioning systems discussed above, serves as the expected channel conditions against which a current CSI value is compared to determine whether the node should be trusted on not trusted. For example, one node may collect a CSI matrix 490 with respect to another node that is to be verified against expected channel conditions. The CSI matrix 490 with respect to the interrogated node is provided as the input to the trained model f(CSI_{m,n}) at 450, which then outputs a determination (e.g., a label) as to whether the node should be verified as a “trusted” node or unverified as a “not trusted.” Then, in 460, the determining node may react according to the network's security policy (e.g., by setting/enforcing a wireless network policy with respect to the node) based on its label (e.g., to quarantine the node, to remove the node from the network, to drop its data packets, to flag the node as requiring investigation, to release the node from quarantine, etc.).

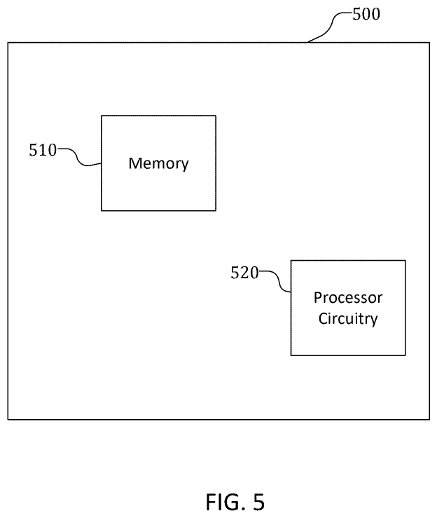

FIG. 5 depicts an apparatus for channel-condition-based provisioning that may include any of the features described above with respect to the onboarding, provisioning, and security verification of wireless nodes, including the descriptions associated with FIGS. 1-4 above. FIG. 5 may be implemented as an apparatus, a device, a system, a method, and/or a computer readable medium that, when executed, performs the features of the sensing systems described above. It should be understood apparatus 500 is only an example, and other configurations may be possible that include, for example, different components or additional components.

Apparatus 500 includes a memory 510 including instructions stored thereon. Apparatus 500 also includes at least one processor circuitry 520 that, based on execution of the instructions stored in memory 510, is configured to determine a set of channel conditions over a plurality of wireless channels between a wireless node and one or more other wireless nodes, wherein the set of channel conditions are based on current channel state information for the plurality of wireless channels. Processor circuitry 520 is also configured to determine a deviation between the set of channel conditions and a set of expected channel conditions for the plurality of wireless channels. Processor circuitry 520 is also configured to set/enforce a wireless network policy with respect to the wireless node based on the deviation.

Furthermore, in addition to or in combination with any of the features described in this or the preceding paragraph, apparatus 500 may be a network controller for or a node of a wireless network. Furthermore, in addition to or in combination with any of the features described in this or the preceding paragraph, the plurality of wireless channels may include channels defined by a wireless local area network (Wi-Fi) and/or a mesh network (Zigbee, Bluetooth, Bluetooth LE, etc.). Furthermore, in addition to or in combination with any of the features described in this or the preceding paragraph, processor circuitry 520 may be configured to set/enforce the wireless network policy includes the processor circuitry configured to prevent the wireless node from joining a wireless communication network with the one or more other wireless nodes. Furthermore, in addition to or in combination with any of the features described in this or the preceding paragraph, the wireless network policy may be of a wireless network, wherein processor circuitry 520 may be configured to set/enforce the wireless network policy includes the processor circuitry configured to quarantine the wireless node from joining a wireless communication network with the one or more other wireless nodes, based on whether (e.g., until) the processor circuitry receives a release to allow the wireless node to join the wireless network.

Furthermore, in addition to or in combination with any of the features described in this or the preceding two paragraphs with respect to apparatus 500, processor circuitry 520 may be configured to set/enforce the wireless network policy with respect to the wireless node based on an extent of the deviation. Furthermore, in addition to or in combination with any of the features described in this or the preceding two paragraphs, processor circuitry 520 may be configured to set/enforce the wireless network policy with respect to the wireless node based on whether the extent of the deviation satisfies a predefined criterion (e.g. a threshold). Furthermore, in addition to or in combination with any of the features described in this or the preceding two paragraphs, processor circuitry 520 may be configured to train the one or more other wireless nodes using historical channel state information (and thus bases the set of expected channel conditions thereon).

Furthermore, in addition to or in combination with any of the features described in this or the preceding three paragraphs with respect to apparatus 500, processor circuitry 520 may be configured to generate a notification based on the deviation, wherein the notification includes an indication that the wireless node deviates from the set of expected channel conditions. Furthermore, in addition to or in combination with any of the features described in this or the preceding three paragraphs, the notification may include a request to allow the wireless node to join a wireless network with the one or more other wireless nodes. Furthermore, in addition to or in combination with any of the features described in this or the preceding three paragraphs, the notification may include an action that one or more of the other wireless nodes should take with respect to communications with the wireless node. Furthermore, in addition to or in combination with any of the features described in this or the preceding three paragraphs, the action may include a refusal to communicate with the wireless node.

Furthermore, in addition to or in combination with any of the features described in this or the preceding four paragraphs with respect to apparatus 500, the set of channel conditions may be associated with a physical location of the wireless node. Furthermore, in addition to or in combination with any of the features described in this or the preceding four paragraphs, the set of expected channel conditions may be based on a prediction model that predicts channel state information for the wireless node at a physical location of the wireless node. Furthermore, in addition to or in combination with any of the features described in this or the preceding four paragraphs, the predication model may be a learning model that has been trained with historical channel state information from other wireless nodes. Furthermore, in addition to or in combination with any of the features described in this or the preceding four paragraphs, the learning model may be configured to determine whether the deviation indicates that the wireless node is trusted for network communications, wherein the processor circuitry may be configured to set/enforce the wireless network policy based on whether the wireless node is trusted for network communications. Furthermore, in addition to or in combination with any of the features described in this or the preceding four paragraphs, the predication model may be a statistical model that correlates historical channel state information to the set of expected channel conditions. Furthermore, in addition to or in combination with any of the features described in this or the preceding four paragraphs, the set of expected channel conditions may be based on historical channel state information for a physical location at which the wireless node is to be located.

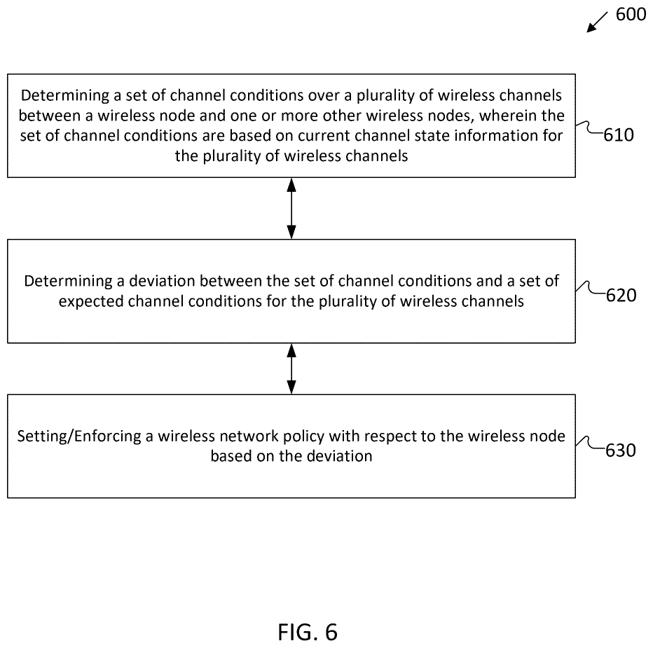

FIG. 6 depicts a schematic flow diagram of a method 600 for channel-condition-based provisioning. Method 600 may implement any of the features discussed above with respect to channel-condition-based provisioning and/or FIGS. 1-5. Method 600 includes, in 610, determining a set of channel conditions over a plurality of wireless channels between a wireless node and one or more other wireless nodes, wherein the set of channel conditions are based on current channel state information for the plurality of wireless channels. Method 600 includes, in 620, determining a deviation between the set of channel conditions and a set of expected channel conditions for the plurality of wireless channels. Method 600 includes, in 630, setting/enforcing a wireless network policy with respect to the wireless node based on the deviation.

In the following, various examples are provided that may include one or more aspects described above with reference to channel-condition-based provisioning and/or any of FIGS. 1-6. The examples provided in relation to the devices may apply also to the described method(s), and vice versa.

Example 011 is an apparatus including a memory including instructions stored thereon. The apparatus also includes at least one processor circuitry that, based on execution of the instructions, is configured to determine a set of channel conditions over a plurality of wireless channels between a wireless node and one or more other wireless nodes, wherein the set of channel conditions are based on current channel state information for the plurality of wireless channels. The processor circuitry is also configured to determine a deviation between the set of channel conditions and a set of expected channel conditions for the plurality of wireless channels. The processor circuitry is also configured to set/enforce a wireless network policy with respect to the wireless node based on the deviation.

Example 122 is the apparatus of example 1, wherein the apparatus includes a network controller for or a node of a wireless network.

Example 3 is the apparatus of any one of examples 1 to 22, wherein the plurality of wireless channels include channels defined by a wireless local area network (Wi-Fi) and/or a mesh network (Zigbee, Bluetooth, Bluetooth LE, etc.).

Example 4 is the apparatus of any one of examples 1 to 23, wherein the processor circuitry configured to set/enforce the wireless network policy includes the processor circuitry configured to prevent the wireless node from joining a wireless communication network with the one or more other wireless nodes.

Example 5 is the apparatus of any one of examples 1 to 24, wherein the wireless network policy is of a wireless network, wherein the processor circuitry configured to set/enforce the wireless network policy includes the processor circuitry configured to quarantine the wireless node from joining a wireless communication network with the one or more other wireless nodes, based on whether (e.g., until) the processor circuitry receives a release to allow the wireless node to join the wireless network.

Example 6 is the apparatus of any one of examples 1 to 25, wherein the processor circuitry is configured to set/enforce the wireless network policy with respect to the wireless node based on an extent of the deviation.

Example 7 is the apparatus of example 26, wherein the processor circuitry is configured to set/enforce the wireless network policy with respect to the wireless node based on whether the extent of the deviation satisfies a predefined criterion (e.g. a threshold).

Example 8 is the apparatus of any one of examples 1 to 27, wherein the processor circuitry is configured to train the one or more other wireless nodes using historical channel state information (and thus bases the set of expected channel conditions thereon).

Example 9 is the apparatus of any one of examples 1 to 28, wherein the processor circuitry is configured to generate a notification based on the deviation, wherein the notification includes an indication that the wireless node deviates from the set of expected channel conditions.

Example 10 is the apparatus of example 29, wherein the notification includes a request to allow the wireless node to join a wireless network with the one or more other wireless nodes.

Example 11 is the apparatus of examples 29 to 210, wherein the notification includes an action that one or more of the other wireless nodes take with respect to communications with the wireless node.

Example 12 is the apparatus of example 211, wherein the action includes a refusal to communicate with the wireless node.

Example 13 is the apparatus of any one of examples 1 to 212, wherein the set of channel conditions is associated with a physical location of the wireless node.

Example 14 is the apparatus of any one of examples 1 to 213, wherein the set of expected channel conditions is based on a prediction model that predicts channel state information for the wireless node at a physical location of the wireless node.

Example 15 is the apparatus of example 214, wherein the predication model is a learning model that has been trained with historical channel state information from other wireless nodes.

Example 16 is the apparatus of example 215, wherein the learning model is configured to determine whether the deviation indicates that the wireless node is trusted for network communications, wherein the processor circuitry is configured to set/enforce the wireless network policy based on whether the wireless node is trusted for network communications.

Example 17 is the apparatus of any one of examples 215 to 216, wherein the predication model is a statistical model that correlates historical channel state information to the set of expected channel conditions.

Example 18 is the apparatus of any one of examples 1 to 217, wherein the set of expected channel conditions is based on historical channel state information for a physical location at which the wireless node is to be located.

Example 21919 is a non-transitory computer-readable medium including instructions that, when executed by one or more processors, cause the one or more processors to determine a set of channel conditions over a plurality of wireless channels between a wireless node and one or more other wireless nodes, wherein the set of channel conditions are based on current channel state information for the plurality of wireless channels. The instructions also cause the one or more processors to determine a deviation between the set of channel conditions and a set of expected channel conditions for the plurality of wireless channels. The instructions also cause the one or more processors to set/enforce a wireless network policy with respect to the wireless node based on the deviation.

Example 192020 is the non-transitory computer-readable medium of example 19, wherein the non-transitory computer-readable medium is in a network controller for or a node of a wireless network.

Example 21 is the non-transitory computer-readable medium of any one of examples 19 to 2020, wherein the plurality of wireless channels include channels defined by a wireless local area network (Wi-Fi) and/or a mesh network (Zigbee, Bluetooth, Bluetooth LE, etc.).

Example 22 is the non-transitory computer-readable medium of any one of examples 19 to 2021, wherein the instructions that cause the one or more processors to set/enforce the wireless network policy includes the one or more processors configured to prevent the wireless node from joining a wireless communication network with the one or more other wireless nodes.

Example 23 is the non-transitory computer-readable medium of any one of examples 19 to 2022, wherein the wireless network policy is of a wireless network, wherein the instructions that cause the one or more processors to set/enforce the wireless network policy also cause the one or more processors to quarantine the wireless node from joining a wireless communication network with the one or more other wireless nodes, based on whether (e.g., until) the one or more processors processor receives a release to allow the wireless node to join the wireless network.

Example 24 is the non-transitory computer-readable medium of any one of examples 19 to 2023, wherein the instructions cause the one or more processors to set/enforce the wireless network policy with respect to the wireless node based on an extent of the deviation.

Example 25 is the non-transitory computer-readable medium of example 2024, wherein the instructions cause the one or more processors to set/enforce the wireless network policy with respect to the wireless node based on whether the extent of the deviation satisfies a predefined criterion (e.g. a threshold).

Example 26 is the non-transitory computer-readable medium of any one of examples 19 to 2025, wherein the instructions also cause the one or more processors to train the one or more other wireless nodes using historical channel state information (and thus bases the set of expected channel conditions thereon).

Example 27 is the non-transitory computer-readable medium of any one of examples 19 to 2026, wherein the instructions also cause the one or more processors to generate a notification based on the deviation, wherein the notification includes an indication that the wireless node deviates from the set of expected channel conditions.

Example 28 is the non-transitory computer-readable medium of example 2027, wherein the notification includes a request to allow the wireless node to join a wireless network with the one or more other wireless nodes.

Example 29 is the non-transitory computer-readable medium of examples 2027 to 2028, wherein the notification includes an action that one or more of the other wireless nodes take with respect to communications with the wireless node.

Example 30 is the non-transitory computer-readable medium of example 2029, wherein the action includes a refusal to communicate with the wireless node.

Example 31 is the non-transitory computer-readable medium of any one of examples 19 to 2030, wherein the set of channel conditions is associated with a physical location of the wireless node.

Example 32 is the non-transitory computer-readable medium of any one of examples 19 to 2031, wherein the set of expected channel conditions is based on a prediction model that predicts channel state information for the wireless node at a physical location of the wireless node.

Example 33 is the non-transitory computer-readable medium of example 2032, wherein the predication model is a learning model that has been trained with historical channel state information from other wireless nodes.

Example 34 is the non-transitory computer-readable medium of example 2033, wherein the learning model is configured to determine whether the deviation indicates that the wireless node is trusted for network communications, wherein the instructions cause the one or more processors is configured to set/enforce the wireless network policy based on whether the wireless node is trusted for network communications.

Example 35 is the non-transitory computer-readable medium of any one of examples 2033 to 2034, wherein the predication model is a statistical model that correlates historical channel state information to the set of expected channel conditions.

Example 36 is the non-transitory computer-readable medium of any one of examples 19 to 2035, wherein the set of expected channel conditions is based on historical channel state information for a physical location at which the wireless node is to be located.

Example 203737 is a method including determining a set of channel conditions over a plurality of wireless channels between a wireless node and one or more other wireless nodes, wherein the set of channel conditions are based on current channel state information for the plurality of wireless channels. The method also includes determining a deviation between the set of channel conditions and a set of expected channel conditions for the plurality of wireless channels. The method also includes setting/enforcing a wireless network policy with respect to the wireless node based on the deviation.

Example 373838 is the method of example 37, wherein the method is used in a network controller for or a node of a wireless network.

Example 39 is the method of any one of examples 37 to 3838, wherein the plurality of wireless channels include channels defined by a wireless local area network (Wi-Fi) and/or a mesh network (Zigbee, Bluetooth, Bluetooth LE, etc.).

Example 40 is the method of any one of examples 37 to 3839, wherein the setting/enforcing the wireless network policy includes preventing the wireless node from joining a wireless communication network with the one or more other wireless nodes.

Example 41 is the method of any one of examples 37 to 3840, wherein setting/enforcing the wireless network policy includes quarantining the wireless node from joining a wireless communication network with the one or more other wireless nodes, based on whether (e.g., until) a release is received that allows the wireless node to join the network.

Example 42 is the method of any one of examples 37 to 3841, the method further including setting/enforcing the wireless network policy with respect to the wireless node based on an extent of the deviation.

Example 43 is the method of example 3842, the method further including setting/enforcing the wireless network policy with respect to the wireless node based on whether the extent of the deviation satisfies a predefined criterion (e.g. a threshold).

Example 44 is the method of any one of examples 37 to 3843, the method further including training the one or more other wireless nodes using historical channel state information (and thus bases the set of expected channel conditions thereon).

Example 45 is the method of any one of examples 37 to 3844, the method further including generating a notification based on the deviation, wherein the generated notification includes an indication that the wireless node deviates from the set of expected channel conditions.

Example 46 is the method of example 3845, wherein the generated notification includes a request to allow the wireless node to join a wireless network with the one or more other wireless nodes.

Example 47 is the method of examples 3845 to 3846, wherein the generated notification includes an action that one or more of the other wireless nodes take with respect to communications with the wireless node.

Example 48 is the method of example 3847, wherein the action includes a refusal to communicate with the wireless node.

Example 49 is the method of any one of examples 37 to 3848, wherein the set of channel conditions is associated with a physical location of the wireless node.

Example 50 is the method of any one of examples 37 to 3849, wherein the set of expected channel conditions is based on a prediction model that predicts channel state information for the wireless node at a physical location of the wireless node.

Example 51 is the method of example 3850, wherein the predication model is a learning model that has been trained with historical channel state information from other wireless nodes.

Example 52 is the method of example 3851, the method further including determining, via the learning model, whether the deviation indicates that the wireless node is trusted for network communications, wherein the setting/enforcing the wireless network policy is based on whether the wireless node is trusted for network communications.

Example 53 is the method of any one of examples 3851 to 3852, wherein the predication model is a statistical model that correlates historical channel state information to the set of expected channel conditions.

Example 54 is the method of any one of examples 37 to 3853, wherein the set of expected channel conditions is based on historical channel state information for a physical location at which the wireless node is to be located.

Example 385555 is a device that includes a means for determining a set of channel conditions over a plurality of wireless channels between a wireless node and one or more other wireless nodes, wherein the set of channel conditions are based on current channel state information for the plurality of wireless channels. The device also includes a means for determining a deviation between the set of channel conditions and a set of expected channel conditions for the plurality of wireless channels. The device also includes a means for setting/enforcing a wireless network policy with respect to the wireless node based on the deviation.

Example 555656 is the device of example 55, wherein the device includes a network controller or a node of a wireless network.

Example 57 is the device of any one of examples 55 to 5656, wherein the plurality of wireless channels include channels defined by a wireless local area network (Wi-Fi) and/or a mesh network (Zigbee, Bluetooth, Bluetooth LE, etc.).

Example 58 is the device of any one of examples 55 to 5657, wherein the means for setting/enforcing the wireless network policy includes a means for preventing the wireless node from joining a wireless communication network with the one or more other wireless nodes.

Example 59 is the device of any one of examples 55 to 5658, wherein the means for setting/enforcing the wireless network policy includes a means for quarantining the wireless node to prevent it from joining a wireless communication network with the one or more other wireless nodes, based on whether (e.g., until) a release is received that allows the wireless node to join the network.

Example 60 is the device of any one of examples 55 to 5659, the device further including a means for setting/enforcing the wireless network policy with respect to the wireless node based on an extent of the deviation.

Example 61 is the device of example 5660, the device further including a means for setting/enforcing the wireless network policy with respect to the wireless node based on whether the extent of the deviation satisfies a predefined criterion (e.g. a threshold).

Example 62 is the device of any one of examples 55 to 5661, the device further including a means for training the one or more other wireless nodes using historical channel state information (and thus bases the set of expected channel conditions thereon).

Example 63 is the device of any one of examples 55 to 5662, the device further including a means for generating a notification based on the deviation, wherein the notification includes a means for indicating that the wireless node deviates from the set of expected channel conditions.

Example 64 is the device of example 5663, wherein the notification includes a request to allow the wireless node to join a wireless network with the one or more other wireless nodes.

Example 65 is the device of examples 5663 to 5664, wherein the notification includes an action that one or more of the other wireless nodes take with respect to communications with the wireless node.

Example 66 is the device of example 5665, wherein the action includes a refusal to communicate with the wireless node.

Example 67 is the device of any one of examples 55 to 5666, wherein the set of channel conditions is associated with a physical location of the wireless node.

Example 68 is the device of any one of examples 55 to 5667, wherein the set of expected channel conditions is based on a prediction model that predicts channel state information for the wireless node at a physical location of the wireless node.

Example 69 is the device of example 5668, wherein the predication model is a learning model trained by historical channel state information from other wireless nodes.

Example 70 is the device of example 5669, the device further including a means for determining, via the learning model, whether the deviation indicates that the wireless node is trusted for network communications, wherein the means for setting/enforcing the wireless network policy is based on whether the wireless node is trusted for network communications.

Example 71 is the device of any one of examples 5669 to 5670, wherein the predication model is a statistical model that correlates historical channel state information to the set of expected channel conditions.

Example 72 is the device of any one of examples 55 to 5671, wherein the set of expected channel conditions is based on historical channel state information for a physical location at which the wireless node is to be located.

Example 567373 is a system including a memory including instructions stored thereon. The system also includes at least one processor that, based on execution of the instructions, is configured to determine a set of channel conditions over a plurality of wireless channels between a wireless node and one or more other wireless nodes, wherein the set of channel conditions are based on current channel state information for the plurality of wireless channels. The processor is also configured to determine a deviation between the set of channel conditions and a set of expected channel conditions for the plurality of wireless channels. The processor is also configured to set/enforce a wireless network policy with respect to the wireless node based on the deviation.

Example 737474 is the system of example 73, wherein the system includes a network controller for or a node of a wireless network.

Example 75 is the system of any one of examples 73 to 7474, wherein the plurality of wireless channels include channels defined by a wireless local area network (Wi-Fi) and/or a mesh network (Zigbee, Bluetooth, Bluetooth LE, etc.).

Example 76 is the system of any one of examples 73 to 7475, wherein the processor configured to set/enforce the wireless network policy includes the processor configured to prevent the wireless node from joining a wireless communication network with the one or more other wireless nodes.

Example 77 is the system of any one of examples 73 to 7476, wherein the wireless network policy is of a wireless network, wherein the processor configured to set/enforce the wireless network policy includes the processor configured to quarantine the wireless node from joining a wireless communication network with the one or more other wireless nodes, based on whether (e.g., until) the processor receives a release to allow the wireless node to join the wireless network.

Example 78 is the system of any one of examples 73 to 7477, wherein the processor is configured to set/enforce the wireless network policy with respect to the wireless node based on an extent of the deviation.

Example 79 is the system of example 7478, wherein the processor is configured to set/enforce the wireless network policy with respect to the wireless node based on whether the extent of the deviation satisfies a predefined criterion (e.g. a threshold).

Example 80 is the system of any one of examples 73 to 7479, wherein the processor is configured to train the one or more other wireless nodes using historical channel state information (and thus bases the set of expected channel conditions thereon).

Example 81 is the system of any one of examples 73 to 7480, wherein the processor is configured to generate a notification based on the deviation, wherein the notification includes an indication that the wireless node deviates from the set of expected channel conditions.

Example 82 is the system of example 7481, wherein the notification includes a request to allow the wireless node to join a wireless network with the one or more other wireless nodes.

Example 83 is the system of examples 7481 to 7482, wherein the notification includes an action that one or more of the other wireless nodes take with respect to communications with the wireless node.

Example 84 is the system of example 7483, wherein the action includes a refusal to communicate with the wireless node.

Example 85 is the system of any one of examples 73 to 7484, wherein the set of channel conditions is associated with a physical location of the wireless node.

Example 86 is the system of any one of examples 73 to 7485, wherein the set of expected channel conditions is based on a prediction model that predicts channel state information for the wireless node at a physical location of the wireless node.

Example 87 is the system of example 7486, wherein the predication model is a learning model that has been trained with historical channel state information from other wireless nodes.

Example 88 is the system of example 7487, wherein the learning model is configured to determine whether the deviation indicates that the wireless node is trusted for network communications, wherein the processor is configured to set/enforce the wireless network policy based on whether the wireless node is trusted for network communications.

Example 89 is the system of any one of examples 7487 to 7488, wherein the predication model is a statistical model that correlates historical channel state information to the set of expected channel conditions.

Example 90 is the system of any one of examples 73 to 7489, wherein the set of expected channel conditions is based on historical channel state information for a physical location at which the wireless node is to be located.

While the above has been particularly shown and described with reference to specific aspects, it should be understood by those skilled in the art that various modifications in form and detail may be made thereto without departing from the spirit and scope thereof, and all modifications, which come within the scope and meaning of equivalency, are intended to be embraced.

1. An apparatus comprising:
a memory comprising instructions stored thereon; and
at least one processor circuitry that, based on execution of the instructions, is configured to:
determine a set of channel conditions over a plurality of wireless channels between a wireless node and one or more other wireless nodes, wherein the set of channel conditions are based on current channel state information for the plurality of wireless channels;
determine a deviation between the set of channel conditions and a set of expected channel conditions for the plurality of wireless channels; and
set a wireless network policy with respect to the wireless node based on the deviation.

2. The apparatus of claim 1, wherein the apparatus is a network controller for or a node of a wireless network.

3. The apparatus of claim 1, wherein the plurality of wireless channels comprise channels defined by a wireless network and/or a mesh network.

4. The apparatus of claim 1, wherein the at least one processor circuitry configured to set the wireless network policy comprises the at least one processor circuitry configured to prevent the wireless node from joining a wireless communication network with the one or more other wireless nodes.

5. The apparatus of claim 1, wherein the wireless network policy is of a wireless network, wherein the at least one processor circuitry configured to set the wireless network policy is based on whether the at least one processor circuitry receives a release to allow the wireless node to join the wireless network.

6. The apparatus of claim 1, wherein the at least one processor circuitry is configured to set the wireless network policy with respect to the wireless node based on an extent of the deviation.

7. The apparatus of claim 26, wherein the at least one processor circuitry is configured to set the wireless network policy with respect to the wireless node based on whether the extent of the deviation satisfies a predefined criterion.

8. The apparatus of claim 1, wherein the at least one processor circuitry is configured to train the one or more other wireless nodes based on a historical channel state information.

9. The apparatus of claim 1, wherein the at least one processor circuitry is configured to generate a notification based on the deviation, wherein the notification comprises an indication that the wireless node deviates from the set of expected channel conditions.

10. The apparatus of claim 29, wherein the notification comprises a request to allow the wireless node to join a wireless network with the one or more other wireless nodes.

11. The apparatus of claim 29, wherein the notification comprises an action that one or more of the other wireless nodes take with respect to communications with the wireless node.

12. The apparatus of claim 211, wherein the action comprises a refusal to communicate with the wireless node.

13. The apparatus of claim 1, wherein the set of channel conditions is associated with a physical location of the wireless node.

14. The apparatus of claim 1, wherein the set of expected channel conditions is based on a prediction model that predicts channel state information for the wireless node at a physical location of the wireless node.

15. The apparatus of claim 214, wherein the prediction model is a learning model that has been trained with historical channel state information to predict the channel state information, wherein the learning model is configured to determine whether the deviation indicates that the wireless node is trusted for network communications, wherein the at least one processor circuitry is configured to set the wireless network policy based on whether the wireless node is trusted for network communications.

16. The apparatus of claim 214, wherein the prediction model is a statistical model that correlates historical channel state information to the set of expected channel conditions.

17. A device comprising:
a means for determining a set of channel conditions over a plurality of wireless channels between a wireless node and one or more other wireless nodes, wherein the set of channel conditions are based on current channel state information for the plurality of wireless channels;
a means for determining a deviation between the set of channel conditions and a set of expected channel conditions for the plurality of wireless channels; and
a means for setting a wireless network policy with respect to the wireless node based on the deviation.

18. The device of claim 17, the device further comprising a means for predicting channel state information for the wireless node for a physical location of the wireless node.

19. A non-transitory computer-readable medium comprising instructions that, when executed by one or more processors, cause the one or more processors to:
determine a set of channel conditions over a plurality of wireless channels between a wireless node and one or more other wireless nodes, wherein the set of channel conditions are based on current channel state information for the plurality of wireless channels;
determine a deviation between the set of channel conditions and a set of expected channel conditions for the plurality of wireless channels; and
set a wireless network policy with respect to the wireless node based on the deviation.

20. The non-transitory computer-readable medium of claim 19, wherein the instructions that cause the one or more processors to set the wireless network policy further cause the one or more processors to prevent the wireless node from joining a wireless communication network with the one or more other wireless nodes.
